(19) United States
(12) Patent Application Publication
(10) Pub. No.: US 2026/0069959 A1
(43) Pub. Date: Mar. 12, 2026

(54) Systems and Methods For Real-Time Team Positional Predictions

(71) Applicant: VOLLEY THEORY, Chicago, IL (US)

(72) Inventor: Troy Campbell, Chicago, IL (US)

(21) Appl. No.: 19/322,438

(22) Filed: Sep. 8, 2025

Related U.S. Application Data
(60) Provisional application No. 63/693,582, filed on Sep. 11, 2024.

(51) Int. Cl. A63B 71/06; A63B 24/00; G06V 20/40

(52) U.S. Cl. CPC A63B 71/0622; A63B 24/0062; G06V 20/42; A63B 2243/0095

(57) ABSTRACT

Techniques for real-time positional predictions are disclosed herein. An example computer-implemented method includes receiving (i) a set of performance data corresponding to a team and (ii) data indicating an opposing team. The method includes automatically updating a stored set of performance data associated with the team, and automatically determining, by the positional prediction algorithm, (i) predicted lineups for the team and the opposing team or (ii) predicted team member matchups. The method includes receiving an updated set of performance data during an interval between play of a match, and automatically determining in real-time during the interval, by the positional prediction algorithm, (i) an updated predicted lineup for the team and the opposing team or (ii) updated predicted team member matchups. The method includes causing the updated predicted lineup and the updated plurality of predicted team member matchups to be rendered in a graphical user interface (GUI) during the interval.

### CROSS-REFERENCE TO RELATED APPLICATION

This application claims priority to and the benefit of U.S. Provisional Application Ser. No. 63/693,582, filed on Sep. 11, 2024, entitled “Systems and Methods For Real-Time Team Positional Predictions.” The entire content of the application is incorporated herein by reference in its entirety.

### TECHNICAL FIELD

The present disclosure generally relates to real-time predictions, and more particularly, to enhancing sports prediction and analytics capabilities by leveraging large quantities of performance data and a positional prediction algorithm to predict and optimize team lineups and/or matchups in real-time during matches.

### BACKGROUND

In contemporary volleyball coaching, utilizing statistical analysis to inform decisions about player lineups and game strategies has become increasingly relevant. Traditionally, coaches have relied on their intuition, experience, and available player statistics to determine the optimal lineup for a match. This process involves considering various factors such as player positions, strengths, weaknesses, historical performance data, and corresponding data about the opposing team. However, the reports summarizing performance data from each individual match are typically voluminous (e.g., hundreds of pages), such that manual analysis of these data points can be incredibly time-consuming, if not completely unmanageable. Further, to the extent that contemporary coaches attempt to evaluate this data, their analysis frequently fails to yield significant strategic insights due to the vast number of potential combinations and matchups between players on opposing teams.

Moreover, predicting the lineup and starting positions of an opposing team poses a significant challenge. As mentioned, coaches often have access to previous matches and can analyze trends, but the extensive amount of available data in conjunction with the limited time coaches have between, and especially during, matches effectively eliminates the chance to accurately forecast the opponent's strategy, lineups, and/or resulting rotations. This limitation often prevents coaches from fully optimizing their team's lineup and rotations to exploit the weaknesses of the opposing team effectively.

Therefore, in general, enabling efficient performance data analysis to provide real-time predictions is an area of great interest.

### SUMMARY

In some aspects, the techniques described herein relate to a computer-implemented method for real-time team positional predictions, the method including: receiving, at one or more processors, (i) a set of performance data corresponding to at least one team member of a plurality of team members of a team from a prior match and (ii) data indicating an opposing team for a current match; processing, by the one or more processors, the set of performance data, including: automatically updating, by a positional prediction algorithm, a stored set of performance data associated with the team based on the set of performance data, automatically determining, by the positional prediction algorithm based on the stored set of performance data and a set of opposing team performance data, at least one of: (i) a plurality of predicted lineups for the team and the opposing team; or (ii) a plurality of predicted team member matchups corresponding to the plurality of predicted lineups; receiving, at the one or more processors, an updated set of performance data during an interval between play of the current match between the team and the opposing team, the updated set of performance data indicating performance values of one or more team members of the plurality of team members during the current match before the interval between play; automatically determining in real-time during the interval between play, by the positional prediction algorithm based on at least the updated set of performance data, at least one of: (i) at least one updated predicted lineup for the team and the opposing team; or (ii) an updated plurality of predicted team member matchups corresponding to the at least one updated predicted lineup; and causing, by the one or more processors, the at least one updated predicted lineup and the updated plurality of predicted team member matchups to be rendered as part of a graphical user interface (GUI) during the interval between play of the current match.

In some aspects, the techniques described herein relate to a data processing apparatus including: one or more processors; and one or more memories accessible by the processor, the one or more memories storing thereon a positional prediction algorithm and a computer program configured to access or implement the positional prediction algorithm, wherein the computer program, when executed by the one or more processors, causes the one or more processors to: receive (i) a set of performance data corresponding to at least one team member of a plurality of team members of a team from a prior match and (ii) data indicating an opposing team for a current match, process the set of performance data, including: automatically updating, by the positional prediction algorithm, a stored set of performance data associated with the team based on the set of performance data, automatically determining, by the positional prediction algorithm based on the stored set of performance data and a set of opposing team performance data, at least one of: (i) a plurality of predicted lineups for the team and the opposing team; or (ii) a plurality of predicted team member matchups corresponding to the plurality of predicted lineups, receive an updated set of performance data during an interval between play of the current match between the team and the opposing team, the updated set of performance data indicating performance values of one or more team members of the plurality of team members during the current match before the interval between play, and automatically determine in real-time during the interval between play, by the positional prediction algorithm based on at least the updated set of performance data, at least one of: (i) at least one updated predicted lineup for the team and the opposing team; or (ii) an updated plurality of predicted team member matchups corresponding to the at least one updated predicted lineup.

In some aspects, the techniques described herein relate to a non-transitory computer-readable medium including instructions that, when executed by one or more processors, cause the one or more processors to: receive (i) a set of performance data corresponding to at least one team member of a plurality of team members of a team from a prior match and (ii) data indicating an opposing team for a current match; process the set of performance data, including: automatically updating, by a positional prediction algorithm, a stored set of performance data associated with the team based on the set of performance data, automatically determining, by the positional prediction algorithm based on the stored set of performance data and a set of opposing team performance data, at least one of: (i) a plurality of predicted lineups for the team and the opposing team; or (ii) a plurality of predicted team member matchups corresponding to the plurality of predicted lineups; receive an updated set of performance data during an interval between play of the current match between the team and the opposing team, the updated set of performance data indicating performance values of one or more team members of the plurality of team members during the current match before the interval between play; and automatically determine in real-time during the interval between play, by the positional prediction algorithm based on at least the updated set of performance data, at least one of: (i) at least one updated predicted lineup for the team and the opposing team; or (ii) an updated plurality of predicted team member matchups corresponding to the at least one updated predicted lineup.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing system in which various embodiments of the present disclosure may be implemented.

FIG. 2 depicts an example performance data analysis and positional prediction workflow, in accordance with various embodiments described herein.

FIG. 3A depicts a team schedule GUI, in accordance with various embodiments described herein.

FIG. 3B depicts a team member listing and lineup GUI, in accordance with various embodiments described herein.

FIG. 3C depicts an opposing team member listing and lineup GUI, in accordance with various embodiments described herein.

FIG. 3D depicts an opposing team lineups GUI, in accordance with various embodiments described herein.

FIG. 3E depicts a predicted opposing team lineup GUI, in accordance with various embodiments described herein.

FIG. 3F depicts a predicted team match lineups GUI, in accordance with various embodiments described herein.

FIG. 3G depicts a current match matchup analysis GUI, in accordance with various embodiments described herein.

FIG. 3H depicts a current match single lineup matchup and rotation GUI, in accordance with various embodiments described herein.

FIG. 4 depicts a flow diagram representing an example computer-implemented method, in accordance with various embodiments described herein.

### DETAILED DESCRIPTION

The present techniques introduce a comprehensive computer-implemented method and associated data processing apparatus for real-time team positional predictions (e.g., team member lineups, rotations, etc.), particularly focusing on volleyball matches. This method leverages a positional prediction algorithm to process performance data from both the team and their opponents, enabling the prediction of team lineups and member matchups with a high degree of accuracy. These methods and techniques described herein receive and process a vast array of performance data, automatically update stored performance data, and generate predicted lineups and matchups that are dynamically updated in real-time based on live match performance data. Specifically, the techniques described herein are capable of more quickly and accurately analyzing and making recommendations/predictions using such immense quantities of data in real-time than a coach and/or assisting staff would be capable of performing between matches and/or during matches (e.g., during timeouts or other brief stoppages of play) to adjust and/or otherwise optimize their team's lineups/matchups. This approach not only enhances the strategic planning capabilities of volleyball coaches but also introduces a level of adaptability and precision previously unattainable in real-time sports analytics.

One of the primary features of these techniques is the ability to rank volleyball team rotations based on statistical analysis. By evaluating attackers' pre-match and real-time, in-match statistics (e.g., blocking statistics, serving statistics), the platform ranks each team's rotations for serving and receiving serves. This ranking system, which encompasses 6 serving rotations and 6 serve receive rotations for each team, results in 24 separate rotations between two teams. The systems of the present disclosure then present all possible matchups with any opposing team, totaling 72, based on these rankings. This exhaustive analysis enables coaches to identify advantageous starting positions for their lineup in contrast to their opponents, thereby optimizing their team's potential for success.

The present techniques can perform this analysis in real-time using the positional prediction algorithm to further offer coaches the opportunity to change their lineups during a match. In-match substitutions or lineup changes between games are typically required from coaches in short periods of time (e.g., 1-2 minutes), during which the coach may occasionally receive in-match statistics indicating each team member's performance or a broad characterization of the team's overall performance. Conventionally, these short in-match periods (e.g., during a timeout) were completely insufficient for the coach or other support staff to make accurate determinations regarding how or why to substitute one team member for another or how to adjust the team lineup in between games to optimize the outcome based on actual team member performances during the match. To illustrate, coaches tasked with accurately evaluating the dozens (e.g., 72 total matchups for only 6 of 12 possible players in each team) of possible matchups for any given game is a monumental task, even when the coaches have days to prepare, due to the drastic number of performance statistics available for both teams that each influence whether any individual team member is a quality choice for a particular lineup position. However, for a coach to even consider, much less analyze, all such combinations and statistics during a several minute period (e.g., during a timeout and/or in between games during a match) in which the coach must make any/all adjustments is nearly impossible.

Using the present techniques, the positional prediction algorithm receives these in-match statistics and quickly evaluates them to determine how each team member (and/or opposing team members) is performing and how the team lineup could potentially be improved, either in the current game, or in subsequent games, and may further consider what the opposing team is likely to do based on similar considerations. Based on this evaluation, the positional prediction algorithm outputs updated predicted lineups for the coach's team and the opposing team, and an updated plurality of matchups, so the coach is presented with both team lineups and individual matchups before the timeout or other period between play/games expires to enable the coach to make any necessary substitutions/lineup changes within the allotted time based on high-quality, granular data analysis associated with both participating teams.

As mentioned, another significant aspect of the techniques described herein is the lineup prediction feature. This feature includes predicting the most likely lineup an opponent will use, considering the order of players and their starting positions within the possible 6 rotations. The prediction is based on the opposing team's historical lineup data throughout the season, as potentially compared against the coach's team's strengths/weaknesses to offer insights into their opponents' strategies before the match. This predictive capability is incredibly helpful for pre-match preparations, enabling coaches to tailor their lineup strategies with a higher degree of accuracy. Thus, the lineup prediction feature adds a layer of foresight into opponent strategies, allowing for more nuanced and strategic lineup decisions.

The systems described herein also include a visualization feature that allows coaches to see the matchups they have chosen to understand the likely outcome of such matchups more readily. This aspect provides a graphical representation of the selected matchups, including player positions and the 12 total matchups (e.g., 6 while serving and 6 while serve receiving) chosen by the coach. This visualization aids in understanding the strategic implications of the chosen lineup and how it compares to the opponent's lineup, facilitating a more informed decision-making process. Similar to the lineup prediction feature, the visualization of matchups provides a clear and intuitive understanding of the strategic landscape, that improves the user experience and enables coaches to make decisions with greater confidence and precision.

As a result of these, and other, features described herein, the present techniques yield substantial improvements in the processing efficiency and accuracy of performance data. By leveraging the algorithms described herein to automatically analyze performance data and the prediction of lineups, matchups, and/or rotations, the techniques described herein significantly reduce the time and resources required to make accurate performance evaluations and subsequent lineup/matchup predictions.

As mentioned, performance data available to coaches and coaching staff is typically voluminous and in a variety of formats and locations (e.g., websites, archives, etc.) that create significant challenges for locating and effectively/efficiently interpreting any/all such data. Even coaches/staff with days/weeks (often less) to evaluate the data between matches typically lack the resources to distill the copious amounts of performance data into meaningful, actionable statistics or other indications. Moreover, any data that is distilled is frequently fraught with errors or other erroneous conclusions as a result of the overwhelming challenges presented by large reams of performance data and minimal analysis time/resources. These challenges are significantly increased (i.e., at least doubled) if the coaches/staff attempt to repeat these herculean efforts using the opposing team's performance data, creating a situation where most performance data generated for any given team is underutilized, if not simply ignored. Consequently, conventional techniques suffer from significant challenges and/or are otherwise unable to process performance data efficiently and accurately, and thereby fail to provide timely (e.g., in advance of upcoming matches, during matches), granular (e.g., corresponding to individual team members and overall team-level for each team) insights that coaches can use to reliably improve their team's performance.

The present techniques optimize the processing of the available performance data by efficiently and accurately incorporating all available data in real-time (e.g., 5-30 seconds), allowing coaches/staff to focus on the implications of the performance data without suffering from the limitations of conventional techniques. In other examples, such as when new data, e.g., line-ups and or re-ranking of players, needs to be entered, the present techniques optimize the processing of the available performance data by efficiently and accurately incorporating all available data including time entering the new data between three to six minutes. In yet another example, when completely new data needs to be entered for both teams, for example, entering the data and then processing data may take about five to ten minutes depending upon the competency of the user operating the system. In any case, the positional prediction algorithm intelligently ingests and analyzes the performance data to determine predicted lineups and team member matchups in a manner that is unachievable using conventional techniques. Specifically, the positional prediction algorithm automatically evaluates the data on an individual team member basis to determine rankings for each team member in multiple categories (e.g., serve, receive, at each position in the lineup, etc.) based on customized weightings associated with respective values (e.g., a number of aces, errors, attacking attempts, kills, serving attempts, etc.) included in the performance data.

For example, a team member's number of kills may have a relatively high weighting value for attacker rankings, as kills generally represent offensive effectiveness, but attacking errors may also have a relatively high weighting value acting as an offset to the kills value. The positional prediction algorithm may accordingly rank an individual team member having the highest number of kills on a team as the third best attacker on the team because the team member also has the highest number of attacking errors, reflecting a nuanced understanding that this team member is likely more aggressive than is advisable for their apparently erratic shot selection and/or technique. As another example, the algorithm may determine that the fourth and fifth ranked (individually) defenders on a team consistently perform at a higher level (e.g., statistically significant improvements in dig and block rates) when positioned adjacent to one another in the serve receive lineup and may determine lineup predictions that leverage this positional advantage to improve both team members' performances when defending. As yet another example, the algorithm may determine that the sixth ranked server on a team has significantly better serving performances (e.g., more aces, fewer serving errors) when serving later in a game (e.g., fourth server or later), such that lineup/matchup predictions for the team tend to feature the sixth ranked server relatively far from the first serving position. Accordingly, the positional prediction algorithm evaluates each team member holistically using an in-depth analysis of each team member's specific strengths, weaknesses, synergies with other team members, and/or advantages/weaknesses when matched against opposing team members (e.g., as reflected in prior match data between the two teams), as guided by the specific performance values weightings that indicate the complex correlations and implications between/among the various performance data values, which conventional techniques fail to provide.

As mentioned, the positional prediction algorithm also determines these rankings and subsequent lineups/matchups for the opposing teams to enable lineup/matchup predictions that further maximize/capitalize on known team member (coach's team or opposing team) strengths/weaknesses in any given situation (e.g., serve, serve receive, etc.). To illustrate, the positional prediction algorithm can generate rankings for team members of both teams, predict lineups for both teams, and optimize the lineup for the coach's team in any given scenario. For example, a coach may need to designate their starting lineup prior to the beginning of a game, and the coach may learn at the game that a particular player on the opposing team is unable to play in the game (e.g., injury). In this example, the coach can specify that the particular team member is unavailable for the opposing team, and the positional prediction algorithm may automatically update the predicted lineups in real-time (e.g., 5-10 seconds) to account for the particular team member's absence and provide the coach with an updated, optimal lineup based on the opposing team members available to play in the current game/match. Thus, the positional prediction algorithm lineup efficiently (e.g., in real-time) optimizes the lineups/matchups to maximize the team member's chances for success and the team's overall chances for success (e.g., winning three out of five games/sets in a “best of five” format).

Moreover, the positional prediction algorithm updates a stored set of performance data for the coach's team when receiving new sets of performance data, which further improves the accuracy of the resulting predicted lineups/matchups by continually increasing the volume of data included in the analysis and balancing the most recent performance data with historical performance data. The positional prediction algorithm may also weigh more recent performance data differently than historical data to account for team member development(s) during a season. For example, a particular team member may change their serving style or technique during the season and may begin serving significantly better than they did earlier in the season, such that the team member becomes one of the better servers on the team. In this example, the positional prediction algorithm may recognize a substantial difference in the team member's serving statistics, such that the algorithm may begin discounting (e.g., reducing the weighting associated with) the earlier season performance data suggesting that the team member is a weaker server to position the team member in positions that take more advantage of the team member's improved serve.

Overall, the techniques described herein provide efficient, accurate lineup/matchup predictions that enable coaches to optimally position their team members for success in a manner that was previously unachievable using conventional techniques. This efficiency is particularly crucial during the short intervals between play in a match (e.g., timeouts, breaks between games/sets), where coaches are conventionally unable to receive, much less utilize, accurate interpretations of any provided performance data to make insightful lineup/matchup adjustments. For example, coaches often struggle to adjust lineups/matchups in real-time during these intervals between play to have adequate remaining time to communicate relevant strategies to the team members corresponding to the lineups/matchups, and are forced to send the team out to play without any and/or minimal strategic information. Using the present techniques, the coach receives the optimal lineups/matchups quickly enough to adequately communicate the strategies associated with the lineups/matchups to the team members before they are forced to begin play. The team can therefore play more strategically by understanding the specific advantages they have based on the lineups/matchups the coach has implemented.

In fact, during these intervals between play, coaches are subject to substantial pressure to ensure that individual team members are correctly positioned based on (1) their current performance in conjunction with (2) their current physical status (e.g., levels of exhaustion, etc.). Coaches that are forced to evaluate both during such short intervals, as is required in conventional techniques, are invariably forced to divide their attention between the two considerations, leading to lower quality assessments of one or both. Accordingly, a coach that focuses purely on evaluating performance data during these intervals is at risk of sending physically exhausted/injured team members into games, putting their health at risk. Alternatively, a coach may assume that a team member is physically unfit to play in a fifth game because they played in each of the prior four games and are likely exhausted. If the coach focuses purely on the performance data and does not engage with the team member, the coach may not realize in time that the team member is physically fit to play, which may cost the team the final game if the team member does not play. Thus, the techniques of the present disclosure enable coaches to focus on their team members' current physical health/status during these short intervals by automatically providing updated lineups/matchups with actionable insights in a timeframe that allows for immediate strategic adjustments. The coach can quickly review these predictions/recommendations and move on to ensuring their team members are physically ready to participate in subsequent games/sets.

In addition to the multiple efficiency and accuracy improvements, the present techniques also optimize network usage. The present techniques retrieve performance data from various networked storage locations, for example, using application programming interfaces (APIs), which substantially streamlines the data acquisition process. Conventionally, coaches and/or staff are forced to search through multiple, decentralized platforms for their team's most recent and/or past performance data, which typically involves the coach/staff spending significant time on the network searching through these platforms (e.g., individual websites) and occupying network resources to locate the performance data of interest. The techniques of the present disclosure utilize APIs and/or other methods (e.g., URL identification, keyword searching, navigation and page identification, HTML parsing, data extraction/structuring/cleaning), necessary to access and efficiently retrieve the relevant data (e.g., prior match performance data) from the platforms of interest. Consequently, the present techniques reduce network usage substantially when retrieving performance data at least by eliminating the wasted time, and by extension, wasted network resources dedicated to manually searching multiple, decentralized networked platforms for performance data, as required by conventional techniques.

Furthermore, the present techniques significantly improve memory usage. By converting performance data from a plurality of non-standardized formats into a standardized format, the techniques optimize data storage and retrieval processes, as well as the processing efficiency to evaluate voluminous performance data. Conventionally, the data stored and/or otherwise accessible via the multiple, decentralized platforms each have different formats that are dependent on the hardware and/or the software utilized by the platform administrator (e.g., university, sports organization, etc.). When retrieved, coaches/staff then frequently need to spend significant time locating the analogous performance data values in each data set to determine a consensus value for each data value of interest. If coaches/staff do not spend this time to painstakingly correlate and/or otherwise evaluate the data from each/multiple sources, then individual coaches/staff may base their analysis on different statistics or may each be forced to evaluate the copious, non-standardized data independently, which can lead to dramatic inaccuracies and/or duplicitous efforts between/among the coaches/staff.

By contrast, the present techniques automatically standardize the retrieved data into a single, standardized format, such that any updates to the stored set of performance data for the team is always in the same format. This standardization expedites subsequent processing by ensuring that the present techniques only need to identify the relevant performance data values in the non-standardized data once before categorizing everything in the standardized format, where identification can be performed more efficiently by not requiring repeated use of processing intensive algorithms/software, such as optical character recognition (OCR) on scanned copies of performance data tables/reports uploaded to a website. Moreover, the present techniques can readily store and locate the standardized data as part of the stored performance data because the performance data values share analogous data categorizations as the stored performance data, which is generally not true using conventional techniques where the performance data is represented in a wide variety of formats and data categorizations.

The present techniques (e.g., via the positional prediction algorithm) also provide automatic updates to any relevant coaches/staff that the standardized data and/or predictions are ready for analysis to ensure that all relevant coaches/staff have expedient access to the most up-to-date, readily interpretable performance data that includes aggregated and standardized data from any suitable platform and/or composite/averaged values that represent a composite/average of all values retrieved from the various platforms. Thus, standardizing the performance data not only facilitates more efficient memory usage but also ensures that the positional prediction algorithm can process data from diverse sources and alert relevant individuals of changes/updates to the stored performance data without the need for manual data format conversions or any other inefficient processes.

The detailed description of the present techniques, grounded in the disclosed positional prediction application/algorithm, elucidates the method's ability to provide real-time, data-driven predictions that support volleyball coaches in making informed strategic decisions. By leveraging performance data from past and current matches, the method offers a unique solution to the challenge of predicting opponent lineups, formulating effective team lineups and rotations, and implementing optimal in-match lineup changes/substitutions using updated data received during intervals between play (e.g., timeouts, periods between games). Through its comprehensive analysis, predictive capabilities, and intuitive visualization, the techniques described herein offer volleyball coaches an unparalleled tool for maximizing their team's performance. This approach represents a significant advancement in the field of sports analytics, offering tangible benefits in terms of processing efficiency, network usage optimization, and improved memory management.

In accordance with the above and the disclosure herein, the techniques of the present disclosure improve the functionality of a computing device (e.g., a hosting server such as a central server) at least by analyzing data in a particular way to enhance the efficiency and capabilities of the computing device. The positional prediction algorithm, executing on the computing device, generates predicted lineups and matchups with an efficiency and accuracy not achieved using conventional techniques. That is, the present disclosure describes improvements in the functioning of the computer itself because the computing device more efficiently analyzes data as a direct result of the positional prediction algorithm. This improves over the prior art at least because existing systems analyze data too slowly to provide meaningful analysis of voluminous performance data, especially in real-time, and/or are otherwise unable to analyze data with the efficiency resulting from the disclosed positional prediction algorithm and corresponding techniques.

Still further, the present disclosure includes specific features other than what is well-understood, routine, conventional activity in the field, or adding unconventional steps that demonstrate, in various embodiments, particular useful applications, e.g., processing, by the one or more processors, the set of performance data, including: automatically updating, by a positional prediction algorithm, a stored set of performance data associated with the team based on the set of performance data, automatically determining, by the positional prediction algorithm based on the stored set of performance data and a set of opposing team performance data, (i) a plurality of predicted lineups for the team and the opposing team and (ii) a plurality of predicted team member matchups corresponding to the plurality of predicted lineups; receiving, at the one or more processors, an updated set of performance data during an interval between play of the current match between the team and the opposing team, the updated set of performance data indicating performance values of one or more team members of the plurality of team members during the current match before the interval between play; and/or automatically determining in real-time during the interval between play, by the positional prediction algorithm based on at least the updated set of performance data, (i) at least one updated predicted lineup for the team and the opposing team and (ii) an updated plurality of predicted team member matchups corresponding to the at least one updated predicted lineup, among others.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, while described herein primarily in terms of volleyball, it should be appreciated that the techniques described herein may apply to any sport and/or other areas.

### Example Computing System

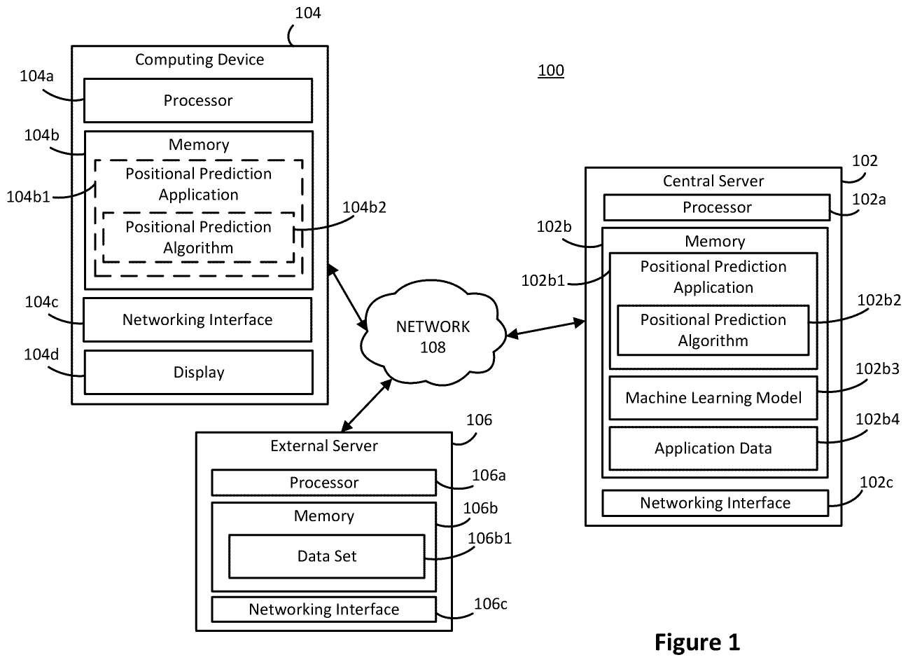

FIG. 1 depicts an example computing system 100 in which various embodiments of the present disclosure may be implemented. Depending on the embodiment, the example computing system 100 may determine/generate predicted lineups, performance data updates, predicted matchups, and/or any related values or combinations thereof. Of course, it should be appreciated that, while the various components of the example computing system 100 (e.g., central server 102, computing device 104, external server 106, etc.) are illustrated in FIG. 1 as single components, the example computing system 100 may include multiple (e.g., dozens, hundreds, thousands) of computing devices 104 and external servers 106 that are simultaneously connected to a network 108 at any given time.

Generally, the example computing system 100 includes a central server 102, a computing device 104, and an external server 106. Each of the central server 102, the computing device 104, and the external server 106 may communicate with the other devices (e.g., transmit data, instructions, etc.) across the network 108. As an example, the central server 102 may belong to a performance data analysis service provider that hosts a positional prediction application 102b1 and a positional prediction algorithm 102b2 for processing sets of performance data, the computing device 104 belongs to a user attempting to interact with the service providing entity, and the external server 106 belongs to a performance data provider (e.g., sporting league, university, etc.). In this example, the user using the computing device 104 may access a positional prediction application 104b1 to provide inputs, and the server 102 may execute the positional prediction application 102b1 and/or the positional prediction algorithm 102b2 to retrieve sets of performance data from the external server 106 and generate predicted lineups/matchups. The central server 102 may make the output data accessible to the user via the computing device 104 (e.g., through the positional prediction application 104b1), so the user may review the output data to review the predictions included therein, provide subsequent input, and/or any other suitable actions or combinations thereof.

More specifically, the central server 102 includes one or more processors 102a, a memory 102b, and a networking interface 102c. The memory 102b stores executable instructions that are configured to, when executed by the one or more processors 102a, cause the one or more processors 102a to analyze data (e.g., sets of performance data, application data 102b4, data set 106b1) received at the central server 102 and output various values (e.g., output data). The positional prediction application 102b1, the positional prediction algorithm 102b2, the machine learning model 102b3, and application data 102b4 may all include such executable instructions, as well as other data. The memory 102b may also store additional data and/or databases. It should be appreciated that the central server 102 can include one or multiple computing devices that are co-located or distributed. Additionally, in certain embodiments, the positional prediction algorithm 102b2 is not included as part of the positional prediction application 102b1.

The central server 102 receives an input, such as updated performance data and/or an opposing team, from the computing device 104 and/or the external server 106 connected to the server 102 through a network 108 and processes the inputs in accordance with one or more sets of instructions stored in a memory 102b to output any of the values described herein. The central server 102 executes the positional prediction application 102b1, which in turn, accesses and applies the positional prediction algorithm 102b2, the machine learning model 102b3, and/or the application data 102b4 to the inputs. The positional prediction algorithm 102b2 then updates stored performance data (e.g., stored in application data 102b4) and/or generates predicted lineups/matchups that represent optimal positions for each team member of a team within a match (e.g., a current match) and/or may provide updated performance data for the team and/or any individual team member(s). The positional prediction application 102b1 also presents the user with one or more visualizations of the predicted lineups/matchups so the user may readily understand what the predictions indicate (e.g., where/when team members are to be positioned, rotated, substituted, etc.), the implications and consequences of each prediction (e.g., likely outcomes resulting from each prediction), and may input adjustments or subsequent requests to the application 102b1. In this manner, the user may quickly interpret and easily understand the outputs of the positional prediction algorithm 102b2 and the positional prediction application 102b1 to make strategic decisions that benefit their team.

The sets of performance data aggregated/retrieved by the positional prediction application 102b1 generally indicate performance statistics of an entire team and the individual team members. For example, a set of performance data indicating post-match performance statistics for a volleyball team may include dozens/hundreds of pages of in-match statistics, such as a number of aces, a number of errors, a number of attacking attempts, a good touch percentage, a number of kills, a number of serving attempts, a hitting percentage, and/or other values or combinations thereof (e.g., kill percentage-kills divided by attacking attempts). These statistics may be divided into groups representative of the entire team (e.g., total kills by the team during the prior match), as well as for each individual team member (e.g., total digs by team member A during the prior match).

When the positional prediction application 102b1 receives the sets of performance data, the application 102b1 may execute the positional prediction algorithm 102b2 to standardize the data, update stored sets of performance data, and analyse the data to provide a multitude of performance indicators and/or predictions (e.g., lineup predictions, matchup predictions, rotation predictions). The stored sets of performance data may be stored on the central server 102 as part of the application data 102b4 and/or may be stored in any suitable location, such as locally on the user computing device 104 and/or on the external server 106 as part of the data set 106b1. The performance indicators are generally indications that accompany the predictions output by the algorithm 102b2 and/or may be provided in response to specific queries/inputs from the user.

A performance indicator may be, for example, recommendations or interpretations of the sets of performance data that may guide coaches/staff to a more nuanced understanding of the predictions provided by the algorithm 102b2 and/or may indicate a trend within the performance data that may not be reflected or otherwise indicated as part of the predictions. For example, a first team member may improve their defensive play steadily throughout the course of a season, the positional prediction algorithm 102b2 may recognize this trend in the sets of performance data (e.g., high numbers of digs and blocks with relatively few reception errors) when compared to the stored performance data (e.g., indicating consistently fewer digs/blocks and higher reception errors). In this example, the positional prediction algorithm 102b2 may provide lineup/matchup prediction that reflects a higher defensive ranking for the first team member along with a performance indicator describing, annotating, and/or otherwise suggesting that the first team member has improved their defensive performance and should most likely be positioned differently than in prior matches to leverage this improvement to the team's advantage.

In any event, the positional prediction algorithm 102b2 may receive a set of performance data, convert the data from a non-standardized format to a standardized format, analyze the data to determine one or more predicted lineups/matchups, and/or store the standardized data as part of the stored sets of performance data (e.g., in the application data 102b4). The algorithm 102b2 may retrieve performance data (e.g., for any team, such as the coach's team and/or any opposing team) from various networked storage locations, such as the external server 106 and/or any storage location(s) that is connected to the network (e.g., websites such as HUDL/Volleymetrics, individual team websites, opponents of opponents webpages as some examples). The algorithm 102b2 may retrieve the performance data, for example, using APIs, which substantially streamline the data acquisition process for websites or other applications where such APIs are available. In some examples, the algorithm 102b2 utilizes URL identification, keyword searching, navigation and page identification, HTML parsing, data extraction/structuring/cleaning, and/or any other suitable actions/functions to access and efficiently retrieve the sets of performance data from the storage locations of interest. Moreover, in certain embodiments, the positional prediction algorithm 102b2 may utilize and/or execute the machine learning model 102b3 to perform or assist in performing one or more of the functions described herein in reference to the positional prediction algorithm 102b2 and/or the positional prediction application 102b1.

In certain embodiments, the application 102b1 may also receive the sets of performance data as files input by a user (e.g., via computing device 104). For example, a coach/staff may manually track performance data of their team during a match. The application 102b1 may retrieve sets of performance data corresponding to the match from networked locations and may additionally receive the manually tracked performance data from the coach, for example, as a scanned document with handwritten or typed values indicating the performance data values (e.g., statistics such as kills, digs, blocks, etc.) for the team and/or individual team members. In these embodiments, the application 102b1 may execute the positional prediction algorithm 102b2 to extract the performance data input by the coach using OCR and/or other image analysis techniques (e.g., thresholding, edge detection, etc.). The algorithm 102b2 may then convert this extracted data into the standardized format for storage as part of the stored set of performance data.

As mentioned, the performance data retrieved/received from the different networked locations is typically formatted in a manner dependent on the specific hardware or software implemented by the location administrator (e.g., sports league entity, university, etc.). Thus, the specific terminology (e.g., kills can sometimes be referenced as “spikes” or “attacks”, digs may be referenced as “defensive saves” or “ball recoveries”), organization (e.g., attacking statistics and defensive statistics may be listed together, separately, on a team-wise basis, or on an individual-by-individual basis), and granularity (e.g., some locations may not provide a kill percentage or an ace-to-attempt ratio) of the performance data stored at the different locations varies considerably. If the positional prediction algorithm 102b2 stored each of these values in their non-standardized state as part of the stored performance data, the data would consume significant memory resources because the differences in the data would prevent the algorithm 102b2 from leveraging several efficient storage processes.

The positional prediction algorithm 102b2 may determine the precited lineups and/or predicted matchups based on the sets of performance data, any portion of the stored performance data (e.g., representing historical performances of the team), and/or performance data of an opposing team. Generally, the positional prediction algorithm 102b2 evaluates the sets of performance data to determine rankings for each individual team member relative to their other team members. For example, a volleyball team typically includes twelve to eighteen players, six of which are allowed on the court at any given time during a match. The composition of these six players includes a combination of front-row players, who are primarily responsible for attacking, blocking, and setting, and back-row players, who specialize in defense, serving, and passing. These six players, along with any others substituted into the match, may accumulate statistics that are included as part of the post-match sets of performance data located on the networked locations and/or acquired by the coach/staff for manual upload.

The positional prediction algorithm 102b2 intakes the sets of performance data and evaluates the individual performance values for each team member to determine any additional statistical values that may not be explicitly included in any set of performance data. For example, a first set of performance data may only include numbers of service attempts and a number of aces for each team member, and the positional prediction algorithm 102b2 may determine an ace-to-attempt ratio for each team member.

The algorithm 102b2 may then determine rankings for each team member in one or more performance areas (e.g., offense, serving, defense) based on the relevant performance data. For example, the positional prediction algorithm 102b2 may determine an offensive ranking, a defensive ranking, and/or a serve ranking for each team member. The offensive ranking may be based on a weighted combination of the team member's attack attempts, attacking efficiency (e.g., success rate), kills, assists, and/or other suitable values or combinations thereof. The defensive ranking may be based on a weighted combination of the team member's blocks, digs, reception errors, and/or other suitable values or combinations thereof. The serve ranking may be based on a weighted combination of the team member's aces, serve attempts, serving errors, serve reception rating, and/or any other suitable values or combinations thereof. Based on a weighted combination of these individual rankings, the algorithm 102b2 may also determine an overall ranking for the team members. The algorithm 102b2 may determine these rankings on a match-by-match basis and/or may aggregate the rankings over the course of a season to determine the team member's overall rankings in each performance area. In this manner, the algorithm 102b2 may provide post-match snapshots of each team member's performance to indicate how each team member is currently performing and may track the development of each team member during a season to determine performance indicators reflecting these seasonal developments (e.g., improvements in certain performance areas over the course of the season).

More specifically, the positional prediction algorithm 102b2 may determine each ranking by applying customized weightings to each performance value. The weightings generally reflect the importance of a particular performance value relative to the other performance values in a similar performance area. For example, kills may have a relatively large weighting value relative to attacking attempts or assists, indicating the importance of kills in evaluating offensive effectiveness. Attacking attempts and attacking efficiency may have slightly lower weighting values. In this example, the offensive rankings for an individual team member may be expressed as the following:

$${w}_{k} k + {w}_{a e} a e + {w}_{a a} a a + {w}_{a} a = O , \qquad ( 1 )$$

where wₖ represents the kills weighting and k represents the number of kills, wₐₑ represents the attacking efficiency weighting and de represents the attacking efficiency, wₐₐ represents the attacking attempts weighting and aa represents the number of attacking attempts, wₐ represents the assists weighting and a represents the number of assists, and 0 represents the team member's weighted offensive value. The algorithm 102b2 may calculate an offensive value for each team member using equation (1) and may rank the team members based on the weighted offensive values for each team member, such that a team member with a higher weighted offensive value may have a higher offensive ranking. Additionally, or alternatively, the algorithm 102b2 may incorporate statistics from other teams/leagues to influence the rankings (e.g., league-wide rankings), and/or otherwise inform the analysis of the team members' performance values. Moreover, the algorithm 102b2 may also determine rankings for opposing teams using equation (1), as applied to the opposing team sets of performance data.

In certain embodiments, the algorithm 102b2 may dynamically adjust these weighting values based on the specific strategies employed by a particular coach/team to more accurately account for the effectiveness of a team member as part of the overall strategy. For example, a team may utilize a strategy that involves a particular team member being positioned or otherwise encouraged to setup their other team members for attacking opportunities because the particular team member is the most effective at performing setups (e.g., assists) that lead to quality offensive opportunities. The coach may provide a strategic input indicating this strategy for the particular team member and/or the algorithm 102b2 may automatically detect this strategic advantage. For example, the algorithm 102b2 may automatically review the sets of performance data and/or the stored sets of performance data to determine that the particular team member's assists are substantially higher at various positions and/or during particular scenarios during matches (e.g., critical points, sets/games, etc.) and/or have a statistically significant covariant relationship with positive team/team member performance when the particular team member is positioned at one or more specific locations within the lineup.

The algorithm 102b2 may also determine rankings for each possible lineup for either team (e.g., coach's team, opposing team) and rotations for each individual lineup. Based on the individual team member rankings, the positional prediction algorithm 102b2 may rank each rotation for the given lineup. For example, the ranking may be in the form of a listing of one through six, where one represents the best/optimal rotation and six represents the worst/least optimal rotation. In this example, the set of rotations associated with the respective lineups may be defined as follows: Team A (e.g., coach's team) has six serving lineups/rotations and six serve receive lineups/rotations ranked one through six and Team B (e.g., opposing team) may have a corresponding set of ranked serve/serve receive lineups/rotations. Once the algorithm 102b2 ranks all rotations, both serving and receiving serve, the algorithm 102b2 outputs all 72 possible separated matchups. For instance, one of the matchups includes Team A's top (e.g., number one) ranked serving rotation being matched against Team B's lowest (e.g., number six) ranked serve receive rotation, which represents a significant advantage for Team A. Regardless, the algorithm 102b2 determines every possible matchup (e.g., both positive/negative) for both teams based on the team member rankings.

The algorithm 102b2 may evaluate the team member rankings for the coach's team and/or the opposing team, and may predict, for any given lineup of team members, which of the six possible rotations is most likely to be the starting lineup for the opposing team and/or which starting lineup/rotation the coach should choose in the event of any six of the opposing team's rotations. Accordingly, the algorithm 102b2 may provide multiple predicted lineups for the opposing team, along with predicted likelihood values for each lineup indicating the likelihood that the opposing team utilizes the indicated lineup for a given match/game and may further indicate the likely rotations for each lineup with corresponding likelihood values. The algorithm 102b2 may also indicate lineup rankings for the coach's team based on the likely opposing team lineups, along with rotation and individual matchup rankings for each possible lineup, based on the team member rankings and the likely opposing team lineups.

The positional prediction algorithm 102b2 may standardize the sets of performance data by, for example, leveraging machine learning and/or other artificial intelligence algorithms configured to analyze the performance data and determine the standardized categorization for each data value. Additionally, or alternatively, the algorithm 102b2 may utilize a rules-based standardization algorithm that associates known terminology for each data value of interest to store the extracted data value in a storage location associated with the standardized data value. For example, the algorithm 102b2 may retrieve a first and a second performance data set representing the performance of a team during a previous match. The first performance data set may indicate a number of “spikes” for a first team member and the second performance data set may indicate a number of “kills” for the first team member. The algorithms 102b2 may extract the values associated with these fields from both data sets, determine that both values correspond to the standardized data category/value “kills”, and may store both values in the “kills” standardized data category/value as part of the stored sets of performance values.

In this manner, the positional prediction algorithm 102b2 may also leverage one or more efficient storage functions that are enabled by the standardized format. For example, by standardizing the format, the algorithm 102b2 may store the sets of performance data using space-efficient data types, such as by using an 8-bit integer instead of a 32-bit integer when values are small. Any character strings included as part of the performance data sets may be truncated or encoded, as the standardized format may force these strings to follow predictable patterns. Moreover, the algorithm 102b2 may normalize the performance data by separating repeated information into distinct tables or structures that are referenced when needed, which eliminates the need to store duplicate information multiple times, significantly reducing the overall storage requirement.

As an example, the positional prediction algorithm 102b2 may organize the standardized data into one or more structures, such as arrays, matrices, and/or databases that are designed for compact storage. For instance, the statistical data associated with each team member and the team overall may naturally form a grid or table (e.g., indicating each standardized data category (kills, digs, aces, serving attempts, etc.) during matches in a season, individual matches, games, etc.), which can be stored in an array-like structure without the need for additional metadata or separators, which would be necessary in a less structured (non-standardized) format. Moreover, the algorithm 102b2 may leverage indexing or keys to reference, for example, the standardized data categories (e.g., serving errors, reception errors, blocks, etc.) to further optimize storage. Instead of storing this more verbose information repeatedly, the algorithm 102b2 may replace the standardized data categories with smaller indices or keys, reducing the storage space needed.

In some embodiments, by standardizing the sets of performance data, the algorithm 102b2 can more readily compress the stored performance data to easily save storage space. Generally, standardized data is amenable to compression because the data uniformity (e.g., higher redundancy) allows compression algorithms to identify patterns, repetitions, and predictabilities more effectively within the data, leading to higher compression ratios. The algorithm 102b2 may standardize the sets of performance data, store the standardized data as part of the stored sets of performance data, and may compress the stored sets of performance data to achieve smaller resource occupancy within the storage location (e.g., application data 102b4).

In certain embodiments, the algorithm 102b2 may leverage the standardized formatting to improve the processing and potential use of caching mechanisms corresponding to the performance data. Data in a standardized format can generally be processed using uniform procedures, which can be optimized for memory usage. Thus, when the algorithm 102b2 standardizes the sets of performance data prior to storage as part of the stored performance data sets, the standardization avoids the need for multiple processing paths and/or conversions between formats, which can temporarily increase memory usage. Standardized data formats also generally improve the effectiveness of caching mechanisms because, when the data is uniform, the caching algorithms executed as part of the positional prediction algorithm 102b2 can more predictably manage what is stored in memory and what can be offloaded, leading to more efficient use of available memory resources.

The positional prediction algorithm 102b2 may also provide automatic updates/messages to any relevant users (e.g., coaches/staff) that the standardized data and/or predictions are ready for viewing. The algorithm 102b2 may thus ensure that all relevant coaches/staff have expedient access to the most up-to-date, readily interpretable performance data that may include aggregated and standardized data from any suitable platform and/or composite/averaged values that may represent a composite/average of all values retrieved from the various platforms. Further, when the algorithm 102b2 pushes notifications/messages to all connected users (e.g., to computing device 104), the notification/message may also include updates reflecting notable changes in the performance data, such as performance indicators (e.g., match to match, trends through the season, etc.), and/or other notifications that are automatically pushed to users as a result of the application 102b1 (e.g., via algorithm 102b2) receiving/processing the sets of performance data.

In certain embodiments, the positional prediction algorithm 102b2 is stored in a remote location from the central server 102 (e.g., a cloud-based server). In these embodiments, the positional prediction application 102b1 accesses the positional prediction algorithm 102b2 by transmitting inputs (e.g., sets of performance data) to the cloud-based server. The positional prediction algorithm 102b2 analyzes the inputs, generates outputs (e.g., rankings, lineup predictions, rotation predictions, matchup predictions), and the cloud-based server returns these outputs to the positional prediction application 102b1. The positional prediction application 102b1 then causes the outputs to be displayed to a user (e.g., via a GUI displayed on the display 104d).

In certain embodiments, the positional prediction algorithm 102b2 and/or the machine learning model 102b3 utilizes machine learning and/or other artificial intelligence algorithms/techniques to perform one or more of the functions described herein. The positional prediction algorithm 102b2 and/or the machine learning model 102b3 may receive the sets of performance data along with lineup/rotation/matchup rankings and/or standardized data categories as training inputs, and the positional prediction algorithm 102b2 and/or the machine learning model 102b3 learns to generate output data including lineup/rotation/matchup rankings and/or to recognize data within the sets of performance data associated with standardized data categories when receiving subsequent sets of performance data. Generally speaking, machine learning may be implemented through machine learning methods and algorithms. In certain embodiments, the machine learning model(s) utilized as part of the central server 102 is or includes the positional prediction algorithm 102b2 and/or the machine learning model 102b3 configured/trained to determine output data based on inputs that include sets of performance data and/or opposing team indications.

In certain embodiments, the machine learning models described herein (e.g., positional prediction algorithm 102b2, machine learning model 102b3) employ supervised learning, which involves identifying patterns in existing data to make predictions about subsequently received data. Specifically, the machine learning models may be “trained” using training data, which includes example inputs and associated example outputs. Based upon the training data, the machine learning models generate a predictive function which maps outputs to inputs and utilize the predictive function to generate machine learning outputs based upon data inputs. The example inputs and example outputs of the training data may include any of the data inputs or machine learning outputs described herein. In an example embodiment, a processing element may be trained by providing it with a large sample of data with known characteristics or features. In various embodiments, the implemented machine learning methods and algorithms are directed toward at least one of a plurality of categorizations of machine learning, such as supervised learning.

In another embodiment, the positional prediction algorithm 102b2 and/or the machine learning model 102b3 may employ unsupervised learning, which involves finding meaningful relationships in unorganized data. Unlike supervised learning, unsupervised learning does not involve user-initiated training based upon example inputs with associated outputs. Rather, in unsupervised learning, the positional prediction algorithm 102b2 and/or the machine learning model 102b3 may organize unlabeled data according to a relationship determined by at least one machine learning method/algorithm employed by the positional prediction algorithm 102b2 and/or the machine learning model 102b3. Unorganized data may include any combination of data inputs and/or machine learning outputs as described above.

Additionally, or alternatively, the machine learning models described herein may utilize or include natural language processing (NLP) functionality. For example, the input prompts transmitted to the positional prediction algorithm 102b2 and/or the machine learning model 102b3 may include textual data (i.e., text describing team member performance values), and the positional prediction algorithm 102b2 and/or the machine learning model 102b3 may implement NLP algorithms/models to interpret the text included therein when determining the output data including standardized data, predicted lineups/rotations/matchups, etc.

It is to be understood that the machine learning described herein may also comprise retraining, relearning, or otherwise updating models with new, or different, information, which may include information received, ingested, generated, or otherwise used over time. Further, it should be appreciated that, as previously mentioned, the machine learning model(s) described herein may be used to generate output data that includes standardized performance data, predicted lineups/rotations/matchups, and/or any other values, responses, or combinations thereof using artificial intelligence (e.g., a machine learning model of the positional prediction algorithm 102b2) or, in alternative aspects, without using artificial intelligence.

More generally, the computing device 104 is or includes any device that is associated with (e.g., owned and/or operated by) a particular entity that may provide data (e.g., sets of performance data, opposing team indications) that is transmitted to and/or is otherwise accessible by the central server 102 and/or the external server 106 through the network 108. In certain embodiments, the data transmitted to and/or otherwise accessible by the central server 102 and/or the external server 106 is a set of performance data including a set of performance data values and/or opposing team indications that are related to sets of stored performance data that are stored in a storage location as part of the application data 102b4 and/or the data set 106b1. This input data is to be evaluated by the central server 102 and/or the external server 106.

In some embodiments, the computing device 104 is a server or collection of servers, through which, one or more users submit data and/or prompts to the central server 102 via individual computing devices connected to the computing device 104. However, in certain embodiments, the computing device 104 is a personal computing device of that entity/user, such as a smartphone, a tablet, smart glasses, or any other suitable device or combination of devices (e.g., a smart watch plus a smartphone) with wireless communication capability. In the embodiment of FIG. 1, the computing device 104 includes a processor 104a, a memory 104b, a networking interface 104c, and a display 104d. Additionally, or alternatively, the computing device 104 may include and execute the positional prediction application 104b1 and/or the positional prediction algorithm 104b2. For example, the computing device 104 may include an instance of the positional prediction application 104b1, which may access the application 102b1 and the positional prediction algorithm 102b2 hosted on the central server 102.

The computing device 104 is communicatively coupled to the central server 102 and/or the external server 106. For example, the computing device 104, the central server 102, and/or the external server 106 may communicate via USB, Bluetooth, Wi-Fi Direct, Near Field Communication (NFC), etc. For example, the central server 102 may transmit output data indicating standardized/updated sets of performance data, performance indicators, predicted lineups/rotations/matchups, and/or any other values or combinations thereof for transmission to the computing device 104 via the networking interface 102c, which the computing device 104 may receive via the networking interface 104c.

The external server 106 may be or include computing servers and/or combinations of multiple servers storing data that may be accessed/retrieved by the central server 102 and/or the computing device 104. In certain embodiments, the external server 106 receives data from the central server 102 and/or the computing device 104 and retrieves/accesses information stored in memory 106b for transmission back to the central server 102 and/or the computing device 104. The external server 106 may include a processor 106a, a memory 106b, and a networking interface 106c. It should be appreciated that the external server 106 can include one or multiple computing devices that are co-located or distributed.

Further, in certain embodiments, the external server 106 includes a data set 106b1 including data from the computing device 104 and/or the central server 102. In one such example, the external server 106 is a server located in and/or otherwise associated with a performance data service (e.g., a networked platform), and the data set 106b1 is a set of performance data for a particular team stored in memory 106b. As another example, the external server 106 serves as a database for some or all the application data 102b4. In some embodiments, the example computing system 100 does not include the external server 106.

Each of the processors 102a, 104a, 106a may include any suitable number of processors and/or processor types. For example, the processors 102a, 104a, 106a may each include one or more CPUs and one or more graphics processing units (GPUs). Generally, each of the processors 102a, 104a, 106a may be configured to execute software instructions stored in each of the corresponding memories 102b, 104b, 106b. The memories 102b, 104b, 106b may each include one or more persistent memories (e.g., a hard drive and/or solid-state memory) and may store one or more applications, modules, and/or models, such as the positional prediction application 102b1.

The networking interface 102c may enable the central server 102 to communicate with the computing device 104, the external server 106, and/or any other suitable devices or combinations thereof. More specifically, the networking interface 102c enables the central server 102 to communicate with each component of the example computing system 100 across the network 108 through their respective networking interfaces 104c, 106c. The networking interfaces 102c, 104c, 106c may support wired or wireless communications, such as USB, Bluetooth, Wi-Fi Direct, Near Field Communication (NFC), etc. The networking interface 102c may enable the central server 102 to communicate with the various components of the example computing system 100 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

Moreover, the network 108 may be a single communication network, or may include multiple communication networks of one or more types (e.g., one or more wired and/or PANs or LANs, and/or one or more WANs such as the Internet). In some embodiments, the network 108 includes multiple, entirely distinct networks (e.g., one or more networks for communications between central server 102 and computing device 104, and a separate, Bluetooth or wireless LAN (WLAN) network for communications between central server 102 and computing device 104, and so on).

It will be understood that the above disclosure is one example and does not necessarily describe every possible embodiment. As such, it will be further understood that alternate embodiments may include fewer, alternate, and/or additional steps or elements.

### Example Performance Data Analysis Workflows

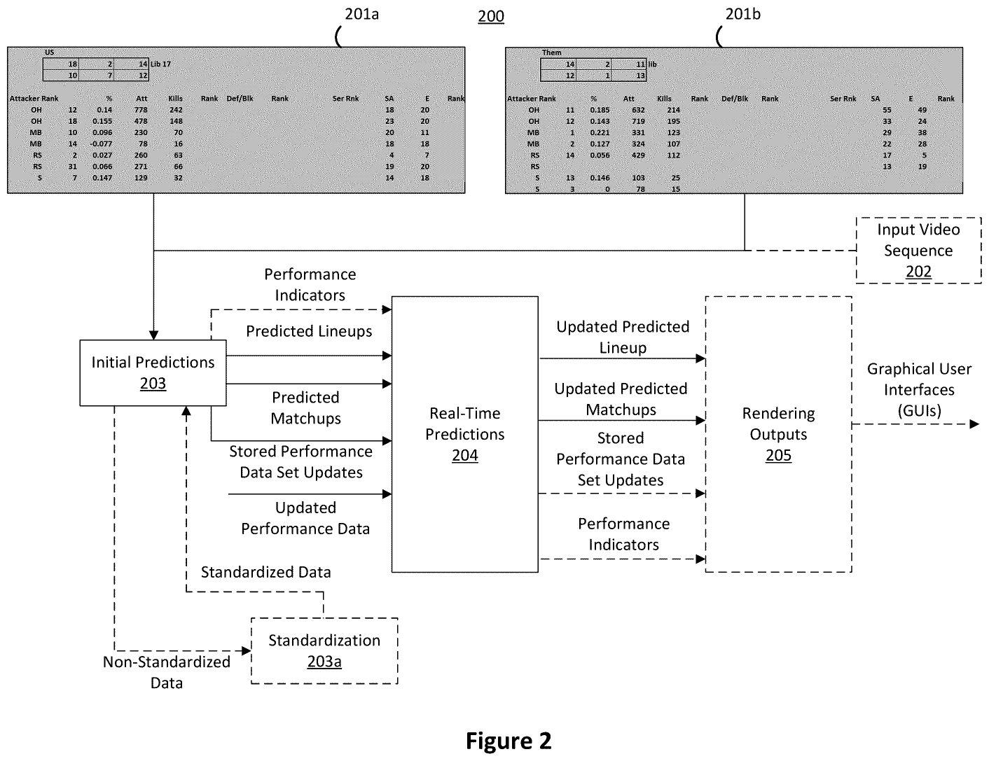

FIG. 2 depicts an example performance data analysis and positional prediction workflow 200, in accordance with various embodiments described herein. The example performance data analysis and positional prediction workflow 200 broadly illustrates a sequence of actions, which may be performed by central server 102 (e.g., processor 102a and/or other components of central server 102) of FIG. 1, for example, to generate/determine output data including standardized data, predicted lineups/rotations/matchups, and/or to cause the output data to be displayed to a user. The example performance data analysis and positional prediction workflow 200 illustrated in FIG. 2 is for the purposes of discussion only, and additional/alternative performance data analysis and positional prediction sequences may also, or instead, be utilized.

The language model image output workflow 200 includes receiving sets of performance data, which are generally illustrated in FIG. 2 as the first set of performance data 201a and the second set of performance data 201b. The first set of performance data 201a and the second set of performance data 201b may represent performance data for a coach's team (e.g., 201a) and an opposing team (e.g., 201b), and each set of performance data 201, 201b includes one or more performance values (e.g., numerical values under “Att”, “Kills”, “SA”, “E”, etc.) associated with the performance areas (e.g., offense, defense, serve, etc.) described herein. These sets of performance data 201a, 201b serve as inputs to the initial predictions block 203. In certain embodiments, the inputs further include an input video sequence 202, which may include video data of a particular match/matches. In these embodiments, the initial predictions block 203 may include performing video/image analysis (e.g., via a convolutional neural network (CNN), thresholding, edge detections, morphological operations, etc.) on the input video sequence 202 to determine one or more performance data values associated with one or more team members of the team represented in the match/matches.

More generally, the initial predictions block 203 includes analyzing the input sets of performance data 201a, 201b to determine one or more predicted lineups, one or more predicted matchups, one or more performance indicators, and/or to update a set of stored performance data. When updating the set of stored performance data, the initial predictions block 203 may further include standardizing the received sets of performance data 201a, 201b from non-standardized data to standardized data at the standardization block 203a. The sets of performance data 201a, 201b illustrated in FIG. 2 may already be in a standardized format, but other received performance data (e.g., directly from a networked storage location, handwritten/manually documented data) may require standardization, as described herein. Thus, at the standardization block 203, the workflow 200 may include converting any non-standardized performance data to a standardized format (e.g., as generally represented by the set of performance data 201a, 201b).

A coach may review the outputs of the initial predictions block 203 and may implement one or more of the predicted lineups or matchups output at the block 203. For example, the initial predictions block 203 may push real-time notifications or messages to one or more connected users (e.g., coach, staff) associated with the team indicating one or more of the predicted lineups, the predicted matchups, the performance indicators, and/or the stored performance data set updates. The coach or staff may review the output data, and may make adjustments or provide other inputs.

When the team begins playing in a match, the workflow 200 may further include receiving updated performance data, which generally indicates one or more in-match performance data values reflecting the performance of the team/team members during a current match (e.g., against an opposing team). This updated performance data, along with any of the outputs from the initial predictions block 203 may be used as inputs at the real-time predictions block 204. While referenced herein as the “real-time predictions block 204”, it should be appreciated that any of the actions described herein in reference to the workflow 200 (e.g., analysis of initial predictions block 203, rendering outputs block 205, standardization block 203a) may be performed in real-time.

The real-time predictions block 204 includes analyzing the updated performance data and/or the predicted lineups/matchups to determine one or more updated predicted lineups, one or more updated predicted matchups, an updated set of stored performance data, and/or one or more updated performance indicators. For example, the updated performance data may indicate that the most likely predicted lineup for the opposing team is not the actual lineup of the opposing team during the first game/set and that several members of the coach's team are playing defense at a significantly higher level than previously indicated as part of the predicted matchups. Accordingly, the real-time predictions block 204 may output an updated predicted lineup that accounts for the actual first lineup used by the opposing team by adjusting the likelihood values associated with all other lineups based on how long the first lineup has been in play (e.g., the first game/set) and/or other additional factors, such as how often the opposing team adjusts their lineup, when they are likely to adjust their lineup, which players are most commonly substituted into/out of the match and when, etc. The real-time predictions block 204 may also output the updated predicted matchups that account for the in-match performance of the team/team members, such as adjusting the viability of one or more rotations based on the updated predicted lineups and how the team/team members are likely to perform based on their better than average in-match defensive play.

Further, the real-time predictions block 204 may output one or more performance indicators representing one or more specific performance values or implications therefrom that may influence the in-match strategy employed by the coach. For example, the updated performance data may indicate that a first team member is serving significantly better than their typical performance and may the performance indicator may include a suggestion/recommendation that the first team member should be positioned to serve near the beginning of the rotation to capitalize on their effective offensive performance.

With one or more of these outputs from the initial predictions block 203 and/or the real-time predictions block 204, the rendering outputs block 205 may cause one or more GUIs to be displayed to a user (e.g., coach, staff) that include some/all of this information. For example, a first GUI may include the one or more predicted lineups, one or more predicted matchups, updated stored performance data, performance indicators, one or more updated predicted lineups, one or more updated predicted matchups, and/or any other suitable values or combinations thereof. Additionally, or alternatively, the GUIs may include one or more real-time alerts/messages/notifications for the user indicating that any of these values or updates are ready to be viewed.

### Example Graphical User Interfaces and Display Elements

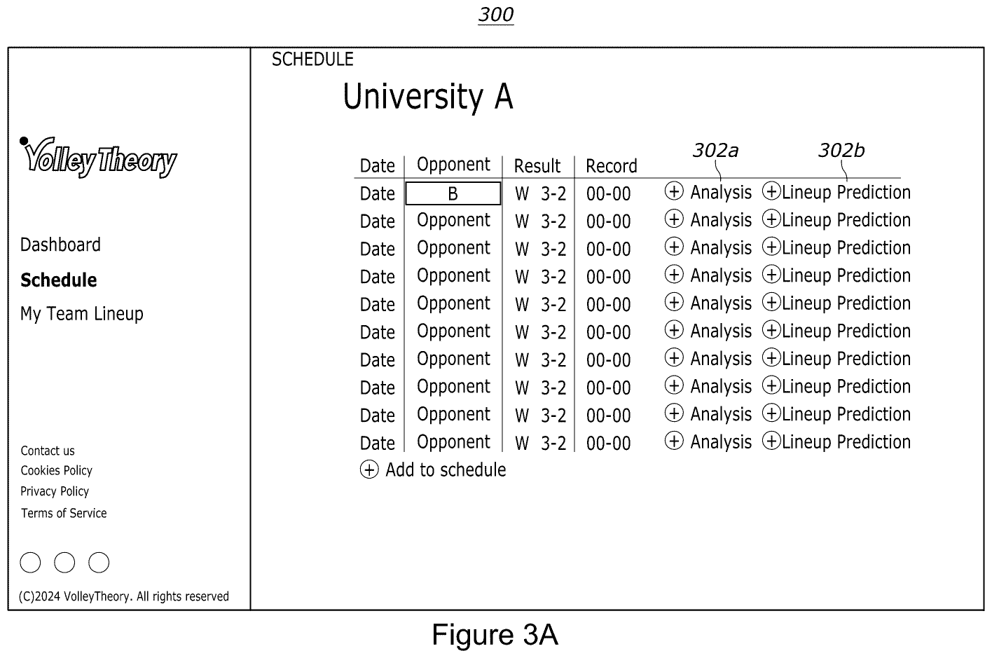

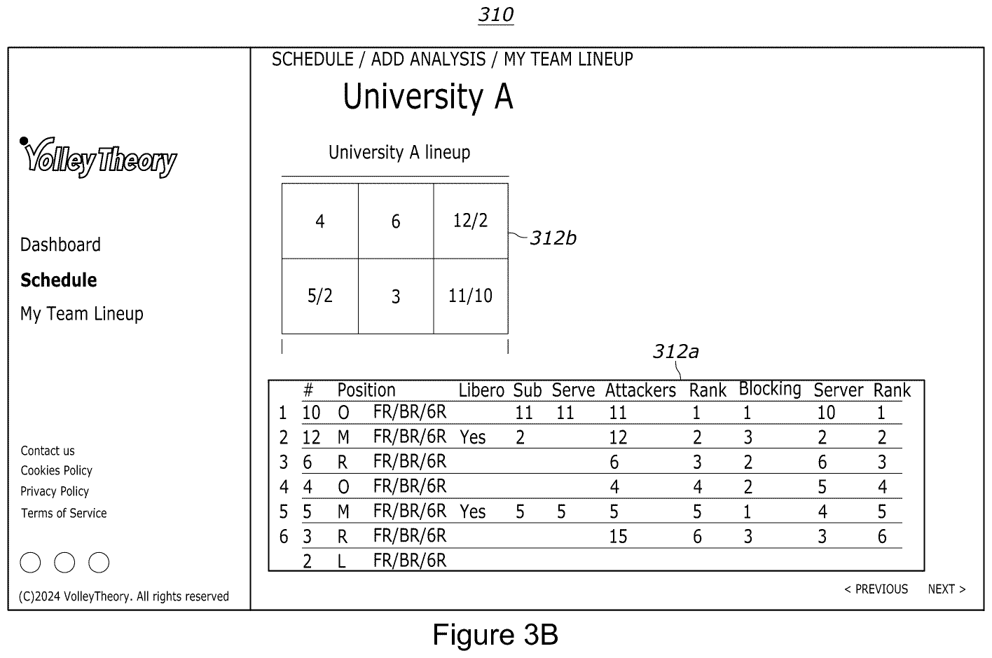

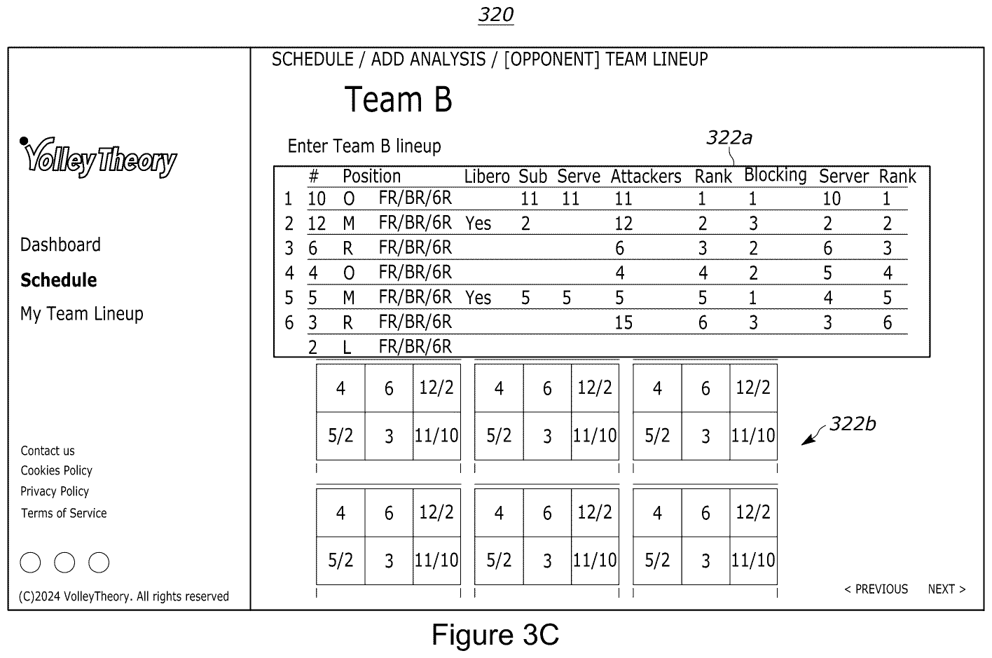

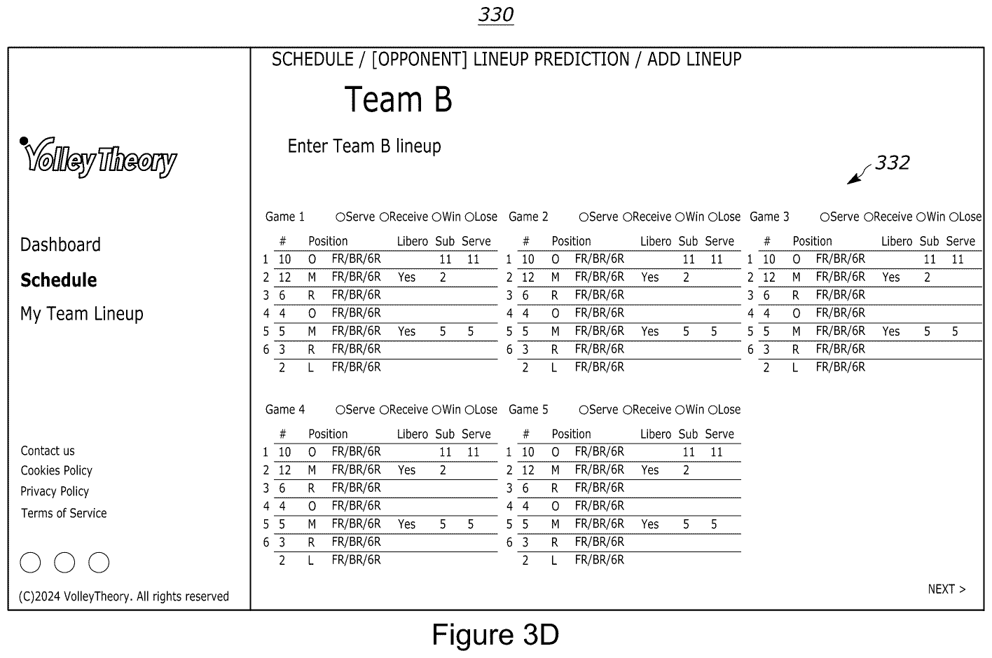

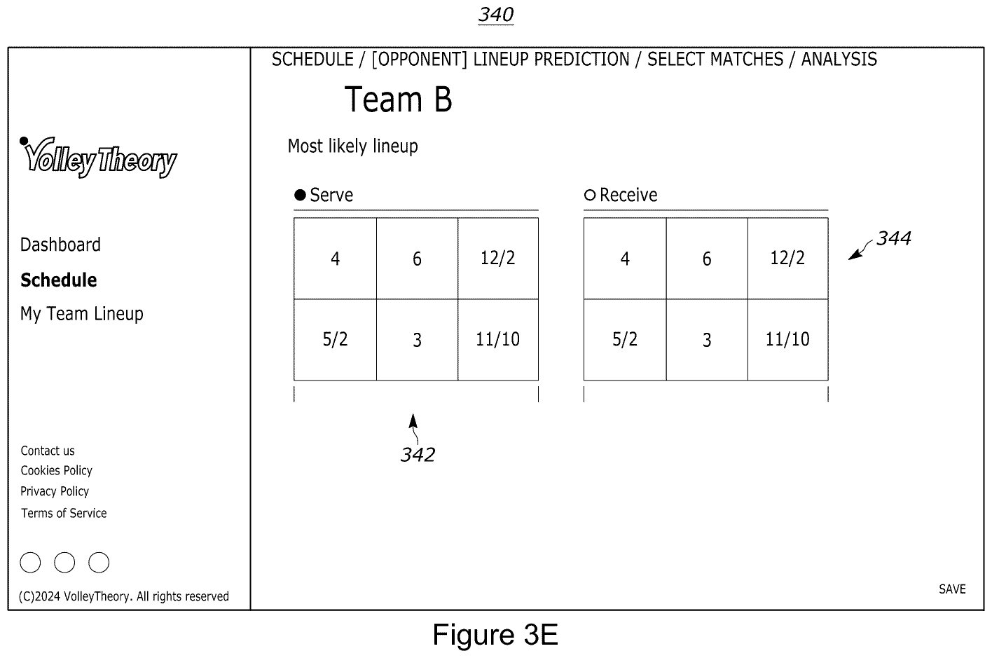

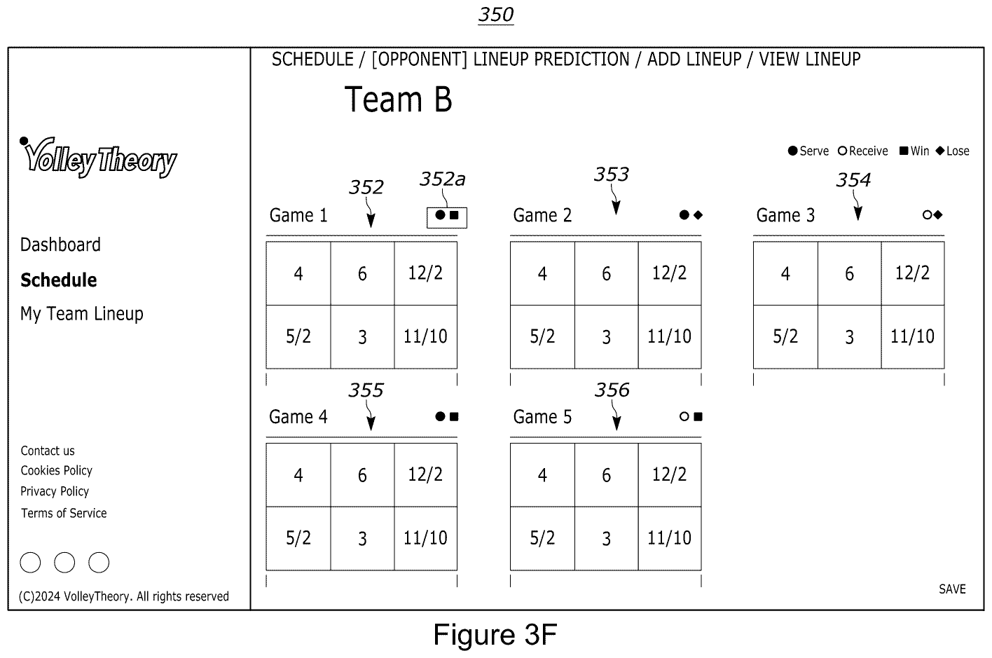

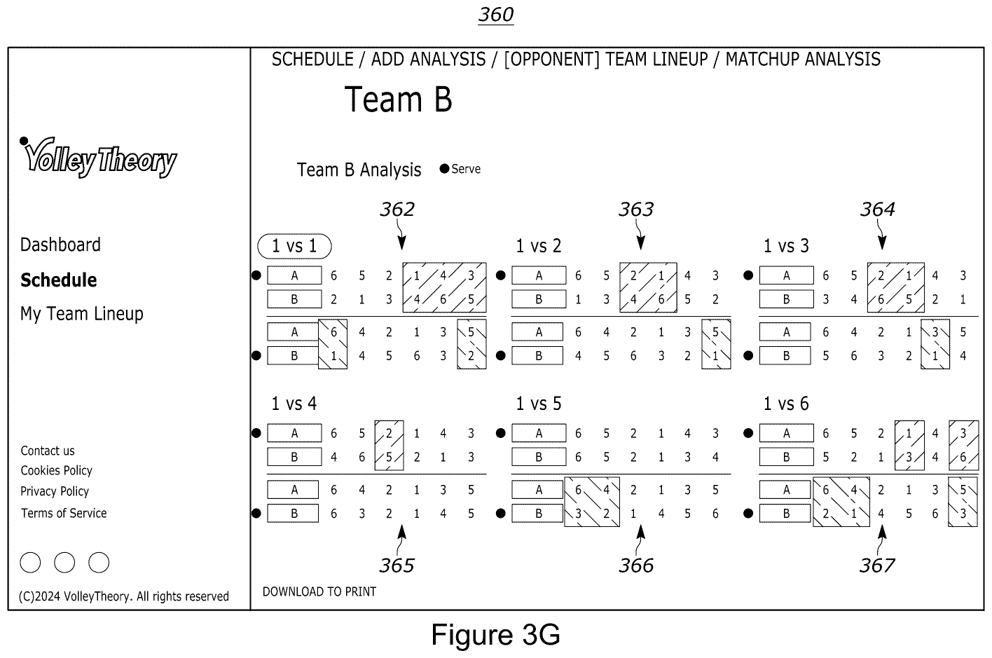

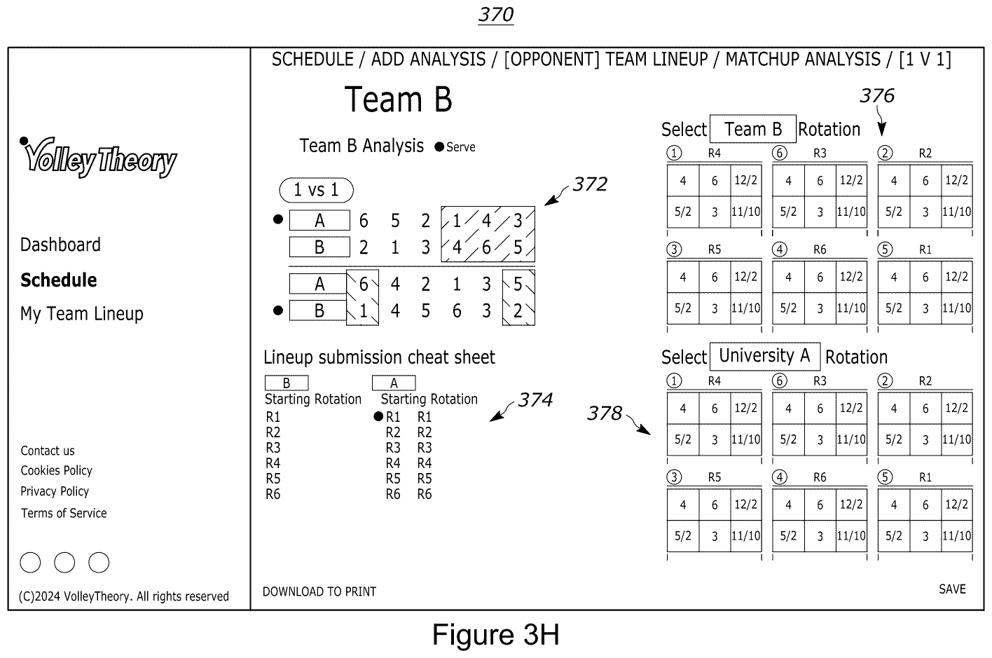

FIG. 3A depicts a team schedule GUI 300, in accordance with various embodiments described herein. Generally, the team schedule GUI 300 represents a screen of an application (e.g., positional prediction application 102b1) that allows a user (e.g., coach) to enter their team's upcoming schedule for a season and/or for any portion of their season. For example, a user associated with the “University A” team depicted in the team schedule GUI 300 has input an opposing team “B” in the first row of the schedule table depicted in the team schedule GUI 300.

The team schedule GUI 300 also includes interactive (e.g., click, tap, swipe, gesture, voice command, etc.) analysis options 302a and interactive lineup prediction options 302b. The user may interact with the interactive analysis options 302a to view performance data for the opposing team, request performance data retrieval for the opposing team, and/or other suitable functions, as described herein. The user may interact with the interactive lineup prediction options 302b to request and/or view lineup predictions, rotation predictions, matchup predictions, and/or any other predictive analysis as described herein related to their team (e.g., “University A”) relative to the opposing team (e.g., Opponent “B”).

FIG. 3B depicts a team member listing and lineup GUI 310, in accordance with various embodiments described herein. The team member listing and lineup GUI 310 generally provides users with a visualization of their team's (e.g., “University A”) team members/roster, and one or more lineups that the team may use during match play. In particular, the GUI 310 includes a team lineup 312a and a default rotation 312b. The user accessing the GUI 310 may add/remove team members from the team lineup 312a, as necessary, and the software/algorithms (e.g., positional prediction algorithm 102b2) included as part of the application (e.g., positional prediction application 102b1) may automatically populate various columns depicted in the team lineup 312a for that team member(s) (e.g., libero, sub, serve, attackers, etc.).

Further, the algorithms included as part of the application may automatically populate the default rotation 312b with one or more team members from the team lineup 312a to provide a suggested lineup. The default rotation 312b may generally represent the lineup(s) that the team typically uses, at least at some point during a match (e.g., first game/set). The default rotation 312b also indicates several planned/expected substitutions that the coach is likely to make during a match. For example, the default rotation 312b includes the team member listing “12/2” indicating that the team member “12” may be included as part of the initial lineup when the match begins, and that the team member “2” may be a libero substitution for team member “12”, as necessary. This default rotation 312b may also be the result of the predictive analysis described herein performed by, for example, the positional prediction algorithm 102b1 of FIG. 1.

FIG. 3C depicts an opposing team member listing and lineup GUI 320, in accordance with various embodiments described herein. The opposing team member listing and lineup GUI 320 generally provides users with a visualization of an opposing team's (e.g., “Team B”) lineup 322a, and one or more predicted rotations 322b that the team may use during match play for the given lineup 322a. In particular, the GUI 320 includes the opposing team lineup 322a and a set of predicted rotations 322b. The user accessing the GUI 320 may add/remove team members from the opposing team lineup 322a, as necessary, and the software/algorithms (e.g., positional prediction algorithm 102b2) included as part of the application (e.g., positional prediction application 102b1) may automatically populate various columns depicted in the team lineup 322a for that team member(s) (e.g., libero, sub, serve, attackers, etc.). Additionally, or alternatively, the software/algorithms included as part of the application may automatically retrieve the most up-to-date team member information (e.g., including new team members) to automatically populate the opposing team rotations 322b, along with any corresponding performance data values associated with the opposing team members.

Further, the algorithms included as part of the application may automatically populate the one or more predicted rotations 322b with one or more team members from the opposing team lineup 322a and/or based on performance data associated with one or more of the team members. The one or more predicted rotations 322b may generally represent the lineup(s) that application has determined are most likely for the opposing team to use, at least at some point during a match (e.g., first game/set). The one or more predicted rotations 322b may also indicate several planned/expected substitutions that the opposing coach is likely to make during a match. For example, one or more of the predicted rotations 322b include the team member listing “5/2” indicating that the team member “5” may be included as part of the initial lineup when the match begins, and that the team member “2” may be a libero substitution for team member “5”, as necessary. These one or more predicted rotations 322b may also be a default set of lineups that are possible and/or are commonly used by the opposing team based on the team members listed in the opposing team lineup 322a and/or prior performance data associated with the opposing team.

FIG. 3D depicts an opposing team lineups GUI 330, in accordance with various embodiments described herein. The opposing team lineups GUI 330 generally includes multiple opposing team lineups 332 that may correspond to one or more lineups that the opposing team may utilize during a match. For example, the application (e.g., positional prediction application 102b1) may retrieve opposing team member performance data for the entire opposing team and may output these opposing team lineups 332 as likely team member lineups the opposing team may use in multiple games/sets of the upcoming match against the coach's team (e.g., University A). The opposing team lineups 332 include a predicted lineup for each game of the match, which the coach may use to adjust their team's lineups prior to the match and/or during the match.

FIG. 3E depicts a predicted opposing team lineup GUI 340, in accordance with various embodiments described herein. The predicted opposing team lineup GUI 340 generally provides a user with one or more predicted opposing team lineups for the serve and receive portions of a match. In particular, the predicted opposing team lineup GUI 340 includes a predicted serve lineup 342 and a predicted serve receive lineup 344. Using these predicted lineups, the user may determine how these lineups may impact their team's performance and/or how they should likely adjust their lineups to take advantage of the most likely lineups used by the opposing team during the match. The predicted lineups 342, 344 may be formatted in the predicted opposing team lineup GUI 340 in a rotation format, such that the user can also/simultaneously view the predicted lineups 342, 344 in a most likely rotation that would be implemented during play.

FIG. 3F depicts a predicted team match lineups GUI 350, in accordance with various embodiments described herein. The predicted team match lineups GUI 350 generally provides user with a set of predicted lineups 352, 353, 354, 355, 356. The predicted lineups 352-356 indicate the likely lineup of the opposing team during each game/set of the match and are generally formatted in a rotation format, such that the user can also/simultaneously view the predicted lineups 352-356 in a most likely rotation that would be implemented during play.

For example, the first predicted lineup 352 indicates the most likely lineup/rotation of the opposing team during the first game/set of the match. The second predicted lineup 353 indicates the most likely lineup/rotation of the opposing team during the second game/set of the match. The third predicted lineup 354 indicates the most likely lineup/rotation of the opposing team during the third game/set of the match. The fourth predicted lineup 355 indicates the most likely lineup/rotation of the opposing team during the fourth game/set of the match. The fifth predicted lineup 356 indicates the most likely lineup/rotation of the opposing team during the fifth game/set of the match.

Each predicted lineup 352-356 may also include match and/or outcome indicators, such as the indicators 352a associated with the first predicted lineup 352. The indicators 352a generally include a first indicator representing the serve/receive status of the opposing team during the first game and a second indicator representing the likely outcome of the game. For example, the first indicator (e.g., illustrated on the left of the two indicators 352a) of the indicators 352a may indicate that the opposing team is likely to serve first during the first game, and the second indicator (e.g., illustrated on the right of the two indicators 352a) of the indicators 352a may indicate that the coach's team is likely to win the first game.

FIG. 3G depicts a current match matchup analysis GUI 360, in accordance with various embodiments described herein. The current match matchup analysis GUI 360 generally depicts a set of predicted matchup analyses 362, 363, 364, 365, 366, 367 for a particular lineup of the user's team (e.g., University “A”) as compared to various rotations of the most likely lineup for the opposing team (e.g., Team “B”). When the user has chosen where to start the team lineup in contrast to the opposing team, the current match matchup analysis GUI 360 depicts the matchups the user has chosen. Generally, within the matchup chosen by the user, there are six matchups of their team's serve versus the opponent team's serve receive and six matchups of their teams' serve receive versus the opponent team's serve, each of which is illustrated in the current match matchup analysis GUI 360.

Each matchup analysis 362-367 features team member indications for the user's team and the opposing team offset to indicate their relative positions to on another. For example, in the first matchup analysis 362, the team member “6” for team “A” is adjacent to team member “2” for the opposing team “B” to represent that the two team members are playing in similar positions against one another.

The first matchup analysis 362 represents the favorable/unfavorable matchups between the user's team members and the opposing team in a first rotation of the user's team and a first rotation of the opposing team for serve and serve receive. Similarly, each of the second matchup analysis 363, the third matchup analysis 364, the fourth matchup analysis 365, the fifth matchup analysis 366, and the sixth matchup analysis 367 may each represent favorable/unfavorable matchups between the user's team members and the opposing team in a first rotation of the user's team and a second, third, fourth, fifth, and/or sixth rotation of the opposing team for serve and serve receive, respectively.

The favorable/unfavorable matchups may generally indicate when a highly ranked team member is matched against a relatively low ranked team member of the opposite team. For example, in the first matchup analysis 362, team A's serve matchup may include three favorable matchups for team A, where the first ranked team member is matched against the fourth ranked team member of the opposing team (e.g., team “B”), the fourth ranked team member is matched against the sixth ranked team member of the opposing team, and the third ranked team member is matched against the fifth ranked team member of the opposing team. Moreover, the team A serve receive rotation represented in the first matchup analysis 362 may include multiple unfavorable matchups where, for example, the sixth ranked team member is matched against the first ranked team member of the opposing team and the fifth ranked team member is matched against the second ranked team member of the opposing team.

FIG. 3H depicts a current match single lineup matchup and rotation GUI 370, in accordance with various embodiments described herein. The current match single lineup matchup and rotation GUI 370 generally indicates multiple aspects of the predicted lineups and/or matchups described herein, such as a predicted matchup 372, a lineup cheat sheet 374, an opposing team rotation set 376, and a team rotation set 378.

The predicted matchup 372 may indicate a matchup chosen by the user and/or output by the algorithms (e.g., positional prediction algorithm 102b2) of the application that may provide the user's team with the optimal chance to win the match against the opposing team. The lineup cheat sheet 374 may provide a condensed indication of the rotations predicted by the algorithms of the application that may provide the user's team with the highest likelihood of success during each game/set, and ultimately, the match. The opposing team rotation set 376 and the team rotation set 378 may generally indicate the rotations indicated in the rotation cheat sheet 374 to provide the user with a convenient visualization of the team members and their respective positions within the rotation, as recommended/predicted by the algorithms of the application.

### Example Computer-Implemented Methods

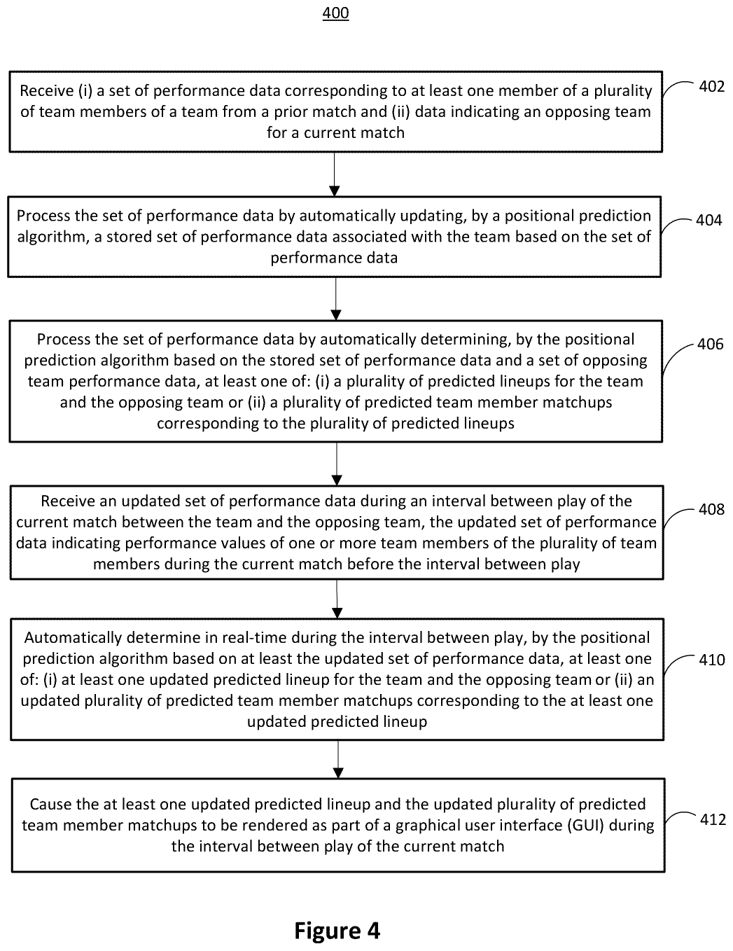

FIG. 4 depicts a flow diagram representing an example computer-implemented method 400, in accordance with various embodiments described herein. The method 400 may be implemented by one or more processors of the example computing system 100, such as the processor 102a of central server 102 (e.g., by positional prediction application 102b1), for example.

The method 400 includes receiving (i) a set of performance data corresponding to at least one team member of a plurality of team members of a team from a prior match and (ii) data indicating an opposing team for a current match (block 402). The method 400 includes processing the set of performance data, including automatically updating, by a positional prediction algorithm, a stored set of performance data associated with the team based on the set of performance data (block 404). The method 400 includes processing the set of performance data, including automatically determining, by the positional prediction algorithm based on the stored set of performance data and a set of opposing team performance data, at least one of: (i) a plurality of predicted lineups for the team and the opposing team; or (ii) a plurality of predicted team member matchups corresponding to the plurality of predicted lineups (block 406).

The method 400 includes receiving an updated set of performance data during an interval between play of the current match between the team and the opposing team (block 408). The updated set of performance data indicating performance values of one or more team members of the plurality of team members during the current match before the interval between play. The method 400 includes automatically determining in real-time during the interval between play, by the positional prediction algorithm based on at least the updated set of performance data, at least one of: (i) at least one updated predicted lineup for the team and the opposing team; or (ii) an updated plurality of predicted team member matchups corresponding to the at least one updated predicted lineup (block 410). The method 400 includes causing the at least one updated predicted lineup and the updated plurality of predicted team member matchups to be rendered as part of a GUI during the interval between play of the current match (block 412).

In certain embodiments, the plurality of predicted team member matchups includes each combination of individual team member matchups between the plurality of team members of the team with team members of the opposing team.

In certain embodiments, each predicted team member matchup of the plurality of predicted team member matchups includes a viability indicator indicating whether the predicted team member matchup is preferable to the team or the opposing team.

In certain embodiments, the set of performance data is received from a plurality of data sources in a plurality of non-standardized formats that are dependent on a hardware platform and a software platform of the respective data source of the plurality of data sources.

In certain embodiments, the method 400 further includes converting, by the positional prediction algorithm, the set of performance data from the plurality of non-standardized formats into a standardized format

In certain embodiments, the interval between play is approximately 60 to 75 seconds.

In certain embodiments, the current match includes a plurality of intervals between play, and the method 400 further includes iteratively receiving, at the one or more processors, updated sets of performance data during each interval of the plurality of intervals between play of the current match, wherein each updated set of performance data indicates performance values of the one or more team members of the plurality of team members during the current match before each respective interval between play; automatically determining in real-time, by the positional prediction algorithm based on at least the updated sets of performance data, at least one of: (i) updated predicted lineups for the team and the opposing team; or (ii) updated pluralities of predicted team member matchups corresponding to the updated predicted lineups; and causing, by the one or more processors, the updated predicted lineups and the updated pluralities of predicted team member matchups to be rendered as part of respective GUIs during each respective interval between play of the current match.

In certain embodiments, receiving the set of performance data further includes retrieving, by the one or more processors via one or more application programming interfaces (APIs), the set of performance data from one or more networked storage locations hosting the set of performance data.

In certain embodiments, the method 400 further includes retrieving, by the one or more processors via one or more APIs, the set of opposing team performance data from one or more networked storage locations hosting the set of opposing team performance data.

In certain embodiments, the set of performance data includes performance values for each team member of the plurality of team members, the performance values corresponding to: (i) a number of aces, (ii) a number of errors, (iii) a number of attacking attempts, (iv) a good touch percentage, (v) a number of kills, (vi) a number of serving attempts, and (vii) a hitting percentage.

In certain embodiments, the method 400 further includes automatically updating in real-time during the interval between play, by the positional prediction algorithm, the stored set of performance data associated with the team based on the updated set of performance data.

In certain embodiments, the updated set of performance data also includes updated performance values of one or more team members of the opposing team.

In certain embodiments, the positional prediction algorithm includes a machine learning model configured to automatically determine the plurality of predicted lineups for the team and the opposing team and the plurality of predicted team member matchups.

In certain embodiments, the set of performance data includes at least one input video sequence corresponding to the team, and wherein the positional prediction algorithm is configured to: process the at least one input video sequence using a convolutional neural network (CNN) to extract one or more performance values from the at least one input video sequence; and update the stored set of performance data based on the one or more performance values extracted from the at least one input video sequence.

In certain embodiments, the method 400 further includes determining a ranking for at least one of: (i) at least one team member of the plurality of team members in at least one performance area based on the stored set of performance data; or (ii) at least one team member of the opposing team in at least one performance data based on the set of opposing team performance data; and automatically determining, by the positional prediction algorithm based on the stored set of performance data, the set of opposing team performance data, and the ranking, at least one of: (i) the plurality of predicted lineups for the team and the opposing team; or (ii) the plurality of predicted team member matchups corresponding to the plurality of predicted lineups.

Of course, it is to be appreciated that the actions of the method 400 may be performed any suitable number of times, and that the actions described in reference to the method 400 may be performed in any suitable order.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method for real-time team positional predictions, the method comprising:
receiving, at one or more processors, (i) a set of performance data corresponding to at least one team member of a plurality of team members of a team from a prior match and (ii) data indicating an opposing team for a current match;
processing, by the one or more processors, the set of performance data, including:
automatically updating, by a positional prediction algorithm, a stored set of performance data associated with the team based on the set of performance data,
automatically determining, by the positional prediction algorithm based on the stored set of performance data and a set of opposing team performance data, at least one of: (i) a plurality of predicted lineups for the team and the opposing team; or (ii) a plurality of predicted team member matchups corresponding to the plurality of predicted lineups;
receiving, at the one or more processors, an updated set of performance data during an interval between play of the current match between the team and the opposing team, the updated set of performance data indicating performance values of one or more team members of the plurality of team members during the current match before the interval between play;
automatically determining in real-time during the interval between play, by the positional prediction algorithm based on at least the updated set of performance data, at least one of: (i) at least one updated predicted lineup for the team and the opposing team; or (ii) an updated plurality of predicted team member matchups corresponding to the at least one updated predicted lineup; and
causing, by the one or more processors, the at least one updated predicted lineup and the updated plurality of predicted team member matchups to be rendered as part of a graphical user interface (GUI) during the interval between play of the current match.

2. The computer-implemented method of claim 1, wherein the plurality of predicted team member matchups includes each combination of individual team member matchups between the plurality of team members of the team with team members of the opposing team.

3. The computer-implemented method of claim 1, wherein each predicted team member matchup of the plurality of predicted team member matchups includes a viability indicator indicating whether the predicted team member matchup is preferable to the team or the opposing team.

4. The computer-implemented method of claim 1, wherein the set of performance data is received from a plurality of data sources in a plurality of non-standardized formats that are dependent on a hardware platform and a software platform of the respective data source of the plurality of data sources.

5. The computer-implemented method of claim 4, further comprising:
converting, by the positional prediction algorithm, the set of performance data from the plurality of non-standardized formats into a standardized format.

6. The computer-implemented method of claim 1, wherein the interval between play is approximately 60 to 75 seconds.

7. The computer-implemented method of claim 1, wherein the current match includes a plurality of intervals between play, and the computer-implemented method further comprises:
iteratively receiving, at the one or more processors, updated sets of performance data during each interval of the plurality of intervals between play of the current match, wherein each updated set of performance data indicates performance values of the one or more team members of the plurality of team members during the current match before each respective interval between play;
automatically determining in real-time, by the positional prediction algorithm based on at least the updated sets of performance data, at least one of: (i) updated predicted lineups for the team and the opposing team; or (ii) updated pluralities of predicted team member matchups corresponding to the updated predicted lineups; and
causing, by the one or more processors, the updated predicted lineups and the updated pluralities of predicted team member matchups to be rendered as part of respective GUIs during each respective interval between play of the current match.

8. The computer-implemented method of claim 1, wherein receiving the set of performance data further comprises:
retrieving, by the one or more processors via one or more application programming interfaces (APIs), the set of performance data from one or more networked storage locations hosting the set of performance data.

9. The computer-implemented method of claim 1, further comprising:
retrieving, by the one or more processors via one or more APIs, the set of opposing team performance data from one or more networked storage locations hosting the set of opposing team performance data.

10. The computer-implemented method of claim 1, wherein the set of performance data includes performance values for each team member of the plurality of team members, the performance values corresponding to: (i) a number of aces, (ii) a number of errors, (iii) a number of attacking attempts, (iv) a good touch percentage, (v) a number of kills, (vi) a number of serving attempts, and (vii) a hitting percentage.

11. The computer-implemented method of claim 1, further comprising:
automatically updating in real-time during the interval between play, by the positional prediction algorithm, the stored set of performance data associated with the team based on the updated set of performance data.

12. The computer-implemented method of claim 1, wherein the updated set of performance data also includes updated performance values of one or more team members of the opposing team.

13. The computer-implemented method of claim 1, wherein the positional prediction algorithm includes a machine learning model configured to automatically determine the plurality of predicted lineups for the team and the opposing team and the plurality of predicted team member matchups.

14. The computer-implemented method of claim 1, wherein the set of performance data includes at least one input video sequence corresponding to the team, and wherein the positional prediction algorithm is configured to:
process the at least one input video sequence using a convolutional neural network (CNN) to extract one or more performance values from the at least one input video sequence; and
update the stored set of performance data based on the one or more performance values extracted from the at least one input video sequence.

15. The computer-implemented method of claim 1, further comprising:
determining, by the one or more processors, a ranking for at least one of: (i) at least one team member of the plurality of team members in at least one performance area based on the stored set of performance data; or (ii) at least one team member of the opposing team in at least one performance data based on the set of opposing team performance data; and
automatically determining, by the positional prediction algorithm based on the stored set of performance data, the set of opposing team performance data, and the ranking, at least one of: (i) the plurality of predicted lineups for the team and the opposing team; or (ii) the plurality of predicted team member matchups corresponding to the plurality of predicted lineups.

16. A data processing apparatus comprising:
one or more processors; and
one or more memories accessible by the processor, the one or more memories storing thereon a positional prediction algorithm and a computer program configured to access or implement the positional prediction algorithm,
wherein the computer program, when executed by the one or more processors, causes the one or more processors to:
receive (i) a set of performance data corresponding to at least one team member of a plurality of team members of a team from a prior match and (ii) data indicating an opposing team for a current match,
process the set of performance data, including:
automatically updating, by the positional prediction algorithm, a stored set of performance data associated with the team based on the set of performance data,
automatically determining, by the positional prediction algorithm based on the stored set of performance data and a set of opposing team performance data, at least one of: (i) a plurality of predicted lineups for the team and the opposing team; or (ii) a plurality of predicted team member matchups corresponding to the plurality of predicted lineups,
receive an updated set of performance data during an interval between play of the current match between the team and the opposing team, the updated set of performance data indicating performance values of one or more team members of the plurality of team members during the current match before the interval between play, and
automatically determine in real-time during the interval between play, by the positional prediction algorithm based on at least the updated set of performance data, at least one of: (i) at least one updated predicted lineup for the team and the opposing team; or (ii) an updated plurality of predicted team member matchups corresponding to the at least one updated predicted lineup.

17. The data processing apparatus of claim 16, wherein the plurality of predicted team member matchups includes each combination of individual team member matchups between the plurality of team members of the team with team members of the opposing team.

18. The data processing apparatus of claim 16, wherein each predicted team member matchup of the plurality of predicted team member matchups includes a viability indicator indicating whether the predicted team member matchup is preferable to the team or the opposing team.

19. The data processing apparatus of claim 16, wherein the positional prediction algorithm includes a machine learning model configured to automatically determine the plurality of predicted lineups for the team and the opposing team and the plurality of predicted team member matchups.

20. A non-transitory computer-readable medium including instructions that, when executed by one or more processors, cause the one or more processors to:
receive (i) a set of performance data corresponding to at least one team member of a plurality of team members of a team from a prior match and (ii) data indicating an opposing team for a current match;
process the set of performance data, including:
automatically updating, by a positional prediction algorithm, a stored set of performance data associated with the team based on the set of performance data,
automatically determining, by the positional prediction algorithm based on the stored set of performance data and a set of opposing team performance data, at least one of: (i) a plurality of predicted lineups for the team and the opposing team; or (ii) a plurality of predicted team member matchups corresponding to the plurality of predicted lineups;
receive an updated set of performance data during an interval between play of the current match between the team and the opposing team, the updated set of performance data indicating performance values of one or more team members of the plurality of team members during the current match before the interval between play; and
automatically determine in real-time during the interval between play, by the positional prediction algorithm based on at least the updated set of performance data, at least one of: (i) at least one updated predicted lineup for the team and the opposing team; or (ii) an updated plurality of predicted team member matchups corresponding to the at least one updated predicted lineup.
